(19) United States
(12) Patent Application Publication
(10) Pub. No.: US 2008/0312907 A1
(43) Pub. Date: Dec. 18, 2008

(54) METHOD AND SYSTEM FOR DATA MODELING ACCORDING TO USER PERSPECTIVES

(75) Inventor: Jonathan McCoy, Palo Alto, CA (US)

Correspondence Address: HULSEY IP INTELLECTUAL PROPERTY LAWYERS, P.C., 919 Congress Avenue, Suite 919, AUSTIN, TX, 78701, US

(73) Assignee: PERCEPTION LABS, Austin, TX (US)

(21) Appl. No.: 12/098,996

(22) Filed: Apr. 7, 2008

Related U.S. Application Data
(60) Provisional application No. 60/910,399, filed on Apr. 5, 2007.

(51) Int. Cl. G06F 17/27

(52) U.S. Cl. 704/9; 704/E15.003

(57) ABSTRACT

Techniques for the design and use of a perception modeling language for communicating according to the perspective of at least two communicators. The disclosed method and system provide for forming a model including a predetermined number of states and a plurality of related transitions. The disclosed subject matter represents each of said predetermined number of states according to a plurality of perspectives, said perspectives including a plurality of states and a set of related transitions, and forms a perspective language by deriving a plurality of functions associating said plurality of perspectives for representing at least one actually observable system. Furthermore, the perspective modeling language derives a set of modeling perspectives for modeling said at least one actually observable system.

### RELATED APPLICATIONS

This application claims priority to U.S. Provisional Patent Application No. 60/910,399 entitled, “Method and System for Language Modeling According to User Perspectives” filed Apr. 5, 2007 by inventor Jonathan McCoy and is incorporated herein in its entirety.

### FIELD

The disclosed subject matter relates to communications technologies and methods of communicating. More particularly, this disclosure relates to a novel and improved method and system for modeling data according to user perspectives.

### DESCRIPTION OF THE RELATED ART

Commonly accepted parts of speech in English and many other languages, including nouns, verbs, adjectives, adverbs, prepositions, allow relating words and phrases together meaningfully, and understandably. This formalization of language formalizes a protocol for communicating. Talking, reading, and writing are all more elegant and efficient as a result of formalized rules governing the use of these parts of speech.

Parts of speech, in combination with the higher level grammar rules derived from parts of speech form a language paradigm—a human language paradigm. Most known human languages, because regardless of words, symbols, grammar, culture, or anything else, must be spoken by two or more people. However, nouns and verbs are only one way to describe an object and the function of that object. A noun refers to a person, place or thing and is a most fundamental component that people use to describe the world around them. A verb, on the other hand, describes the events or actions of a noun, providing a most fundamental way to relate the action of a noun over time. Individuals communicate seamlessly about many topics using nouns and verbs, but there may be other ways to describe objects, and the actions of those objects.

Nouns form one class of constructs to describe objects, while verbs form a class of constructs to describe actions of objects. Both nouns and verbs commonly assume a common perceptive reality of each communicator. Each communicator must have a common conception and perception of every person, place or thing around them, and their respective actions in order for efficient and effective communication to result. However, often an object or action may not have the same meaning to each communicator. The result becomes a miscommunication or semantic disconnect between the communicators. Thus, human language inherently exhibits serious limitations.

In the generation and use of computer language, still other limitations exist. Object-oriented modeling, for example, provides a basic and introductory action for software development. It should be easy to understand and follow, as well as generic enough in flow to apply to various software programs. The model focuses on logical separation of classes and their integration of one another. It also illustrates behavior, functionality, communication, and data flow. Object-oriented modeling may be abbreviated or in-depth.

To further illustrate, each class in the model forms an object. Each object exhibits different attributes, one action (or purpose), and input and/or output (of messages). Overall, object-oriented modeling shows sequential actions of a software program, as most objects within the model are designated with a task.

From a human language perspective, each object may be classified as a noun and thus each task or action could be classified as their relational verb. In other words, noun/verb modeling possesses parallel structures to object-oriented modeling. Thus, software programmers use object-oriented modeling to both explain a program in general and as a tool to write many small programs, with each part completing a function of the whole entire program. All parts may then link together to form one unified program. Object-oriented modeling allows software developers to reuse segments of software code in many different programs.

Although object-oriented programming provides a tremendously powerful tool for modeling systems in software, the paradigm faces known challenges. Thus, while hardware development furthers both local and non-local massive concurrency, local concurrency is being enabled by new hardware for 64-bit multi-core microprocessors, multi-chip modules, and high performance interconnect. New hardware non-local concurrency is being enabled by wired and wireless broadband packet switched communications (e.g., Wi-Fi and Ultra wideband communications). Both local and non-local storage capacities are growing exponentially.

The actor model faces issues in computer and communications architecture, concurrent programming languages, and Web Services. These include scalability, including the challenge of scaling up concurrency both locally and non-locally. Transparency also presents a challenge in bridging between local and non-local concurrency. Some researchers, in fact, advocate a strict separation between local concurrency using concurrent programming languages (e.g., Java and C#) from non-local concurrency using SOAP for Web services. Strict separation produces a lack of transparency causing problems when changing between local and non-local Web Services access. Bridging between local and non-local Web Services may even prefer making binary XML or XSD first-class data types in Java and C#. Inconsistency also presents a challenge, because inconsistencies are present in very large knowledge systems involving human information system interactions. These inconsistencies extend also to the documentation and specifications of such large systems (e.g., Microsoft Windows software, etc.), which are themselves internally inconsistent.

Because of these limitations, there is a need for a language providing consistent definition of objects, and which definitions of objects are expressed in terms of other objects using the same definitions.

There is the need for a reflexive architecture that allows an object to be broken down into components using the same method of object definition. In such an architecture, all defined objects in the definition of the object should be translated into components which are universally defined for all observers of a given object.

There is a further need for a language that may be used to define objects in terms of the perspective of any object.

### SUMMARY

The present disclosure includes improved method and system for modeling data according to user perspectives, and provides a language with consistent definitions of objects, where definitions of objects are expressed as a relation to other objects. The disclosed subject matter includes a reflexive architecture that allows an object to be broken down into components using the same method of object definition. In such an architecture, all defined objects should be translated into components which are universally defined for all observers of a language that may be used to define objects in terms of the perspective of any user. In addition, the present disclosure includes a method for the translation of data found in other databases (such as Microsoft Excel) into the perception modeling language.

According to one aspect of the disclosed subject matter, a method and system are provided for the design and use of a perception modeling language for communicating according to the perspective of at least two communicators. The disclosed method and system provide for forming a model including a predetermined number of states and a plurality of related transitions. The disclosed subject matter represents each of said predetermined number of states according to a plurality of perspectives, said perspectives including a plurality of states and a set of related transitions, and forms a perspective language by deriving a plurality of functions associating said plurality of perspectives for representing at least one actually observable system. Furthermore, the perspective modeling language derives a set of modeling perspectives for modeling said at least one actually observable system.

These and other advantages of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages be included within this description, be within the scope of the accompanying claims.

### BRIEF DESCRIPTIONS OF THE DRAWINGS

The features, nature, and advantages of the disclosed subject matter may become more apparent from the detailed description set forth below when taken in conjunction with the drawings in which like reference characters identify correspondingly throughout and wherein:

FIG. 1 is a conceptual depiction of how a human language paradigm seeks to model the real world;

FIG. 2 illustrates problems relating to known language paradigms;

FIG. 3 provides a conceptual illustration of how languages include models of real world environments;

FIG. 4 discloses aspects of the perspectives of the present disclosure;

FIG. 5 presents aspects of the perspective-oriented modeling language of the present disclosure;

FIG. 6 illustrates concepts relating to how the present disclosure models various objects;

FIG. 7 depicts interaction aspects of the modeling environment of the present disclosure;

FIG. 8 shows how the subject matter of the present disclosure allows for efficiently simulation of various environments;

FIG. 9 illustrates the framework of the present disclosure in relation to various known language models;

FIG. 10 provides an implementation of the disclosed subject matter for using the perspective-based modeling language of the present disclosure;

FIG. 11 shows a first example of a computer user interface for enabling the concepts of the disclosed subject matter;

FIGS. 12 through 25 show templates and interfaces for a computer-based embodiment of the presently disclosed subject matter;

FIGS. 26 through 34 provide an illustrative example of the presently disclosed subject matter; and

FIGS. 35 through 42 provide illustrative examples of some of the functions used in the presently disclose subject matter.

### DETAILED DESCRIPTION OF THE SPECIFIC EMBODIMENTS

The present disclosure provides a modeling language, called the perspective-oriented modeling language (PML) based on a perspective-oriented paradigm. PML presents allows for observing, defining, and communicating about the world contrasting with such functions that may occur using known languages. PML avoids the need to use an object/action paradigm wherein each communicator must share a common perspective and perceive the same thing in the same way. Avoiding this predicament empowers PML users with a protocol for communication. Using a perspective-oriented language paradigm facilitates understanding, analyzing, communicating and simulating complex systems more efficiently, completely, and in a scalable manner.

The perspective-oriented paradigm of PML avoids the use of objects in an absolute sense. Objects are created as the result of a defined perspective for the objects. The principle of defining an object perspective enables every object to be defined in terms of such perspective, and eliminates the need to assume a perspective, as is an object/action paradigm. Furthermore, in defining dynamic behavior, the perspective-oriented paradigm generally focuses on the time relation of object states. As a result, the PML paradigm relegates “action” to only one form of time relation. Action is observed by a common, assumed perspective.

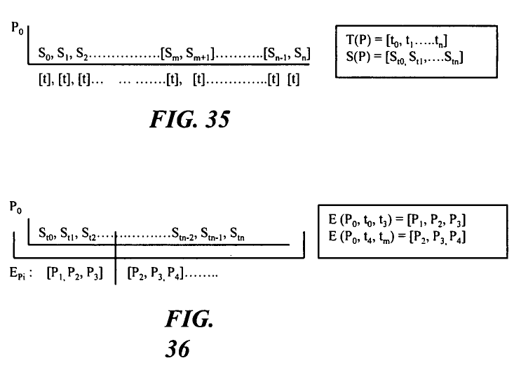

To better appreciate the modeling language of the present disclosure, the following paragraphs provide definitions of various terms as used herein. The term “Perspective” (P) as used herein pertains to an abstract machine, which realizes a formal language, and has a defined relationship with other perspectives. Each perspective has the following properties: “state” (S) and “frequency”. A perspective can have exactly one state at any given time t. The duration of time t, for a given perspective, is constant for the existence of the perspective and is referred to as the “frequency”. One illustrative example of these properties is shown in FIG. 35.

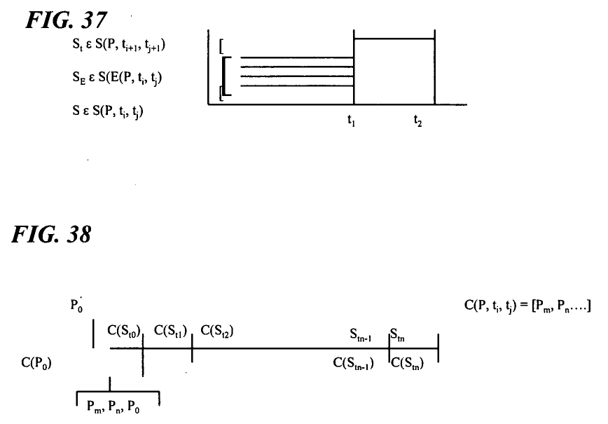

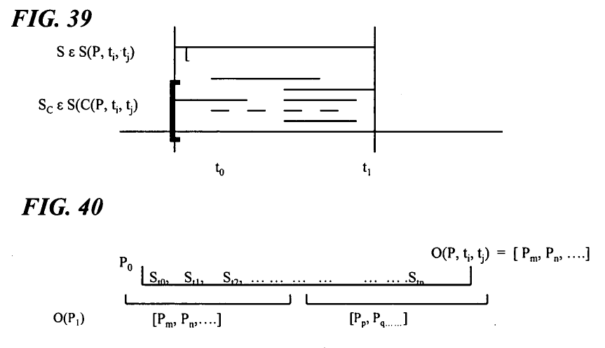

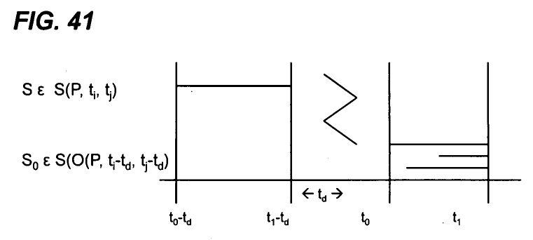

The relationships between perspectives are defined in three ways: “environment” (E), “composition” (C) and “objects” (O). The “environment” defines the set of related perspectives that form the input of the perspectives at a given time t. This relationship is illustrated in FIG. 36. That is for each perspective within E(P, tᵢ, tⱼ)=[Pₘ, Pₙ . . . ], there exists a set of states S[E(P, tᵢ, tⱼ)]=[S (Pₙ), S(P₀), . . . ] such that S(P, tᵢ, tⱼ)×S[E (P, tᵢ, tⱼ)]→S(P, tᵢ₊₁, tⱼ₊₁) for all (tᵢ, tⱼ). This function is illustrated in FIG. 37. The “composition” set defines the set of all related perspectives that form the structure of the perspective at a given time, t. This relationship is illustrated in FIG. 38. That is, for each perspective within C(P, tᵢ, tⱼ)=[Pₘ, Pₙ . . . ] there exists a set of states S(C(P, tᵢ, tⱼ))=[S(Pₘ), S(Pₙ), . . . ] such that S(P, tᵢ, tⱼ)≡S[C(P, tᵢ, tⱼ)] for all (tᵢ, tⱼ). An example of this function is shown in FIG. 39. “Objects” define the set of all related perspectives that observe the state of a perspective at a given time t. An illustrative example of this is given in FIG. 40. That is, for each perspective with O(P, tᵢ, tⱼ)=[Pₘ, Pₙ, . . . ] there exists a set of states S(O(P, tᵢ, tⱼ))=[S(Pₘ), S(Pₙ) . . . ] such that S(O(P, tᵢ, tⱼ)≡S(P, tᵢ₊₁, tⱼ₊₁) for all (tᵢ, tⱼ) An illustrative example of this function is shown in FIG. 41.

There is also an inferred relationship between perceptions. In all Perspective-Object relationships, a “channel” is required to send information as an input to the object. For P, the perspective, and P_{O}εO(P, tᵢ, tⱼ), we can consider a first order “channel” as follows: S(P, tᵢ, tⱼ) S[O(P, tᵢ, tⱼ)]=S(Pₒ, tᵢ+tₒ, tⱼ+tₒ). Therefore: Ch(P, Pₒ, tᵢ, tⱼ)=P_{E} iff P ε E(P_{E}, tᵢ, tⱼ) AND P_{E} ε E[Pₒ, tᵢ+(t_{d}−tₒ), tⱼ+(t_{d}−tₒ)] where t_{d} is the frequency of P_{E} and tₒ is the frequency of Pₒ. The channel links related perspectives together to further define each perspective, as all perspectives are defined by their relationship to other perspectives. The channel is only one of several possible inferred relationships, which also include: n-order compositions, n-order objects (also called interactions), and n-order temporal relationships. These relationships may be apparent to those skilled in the art.

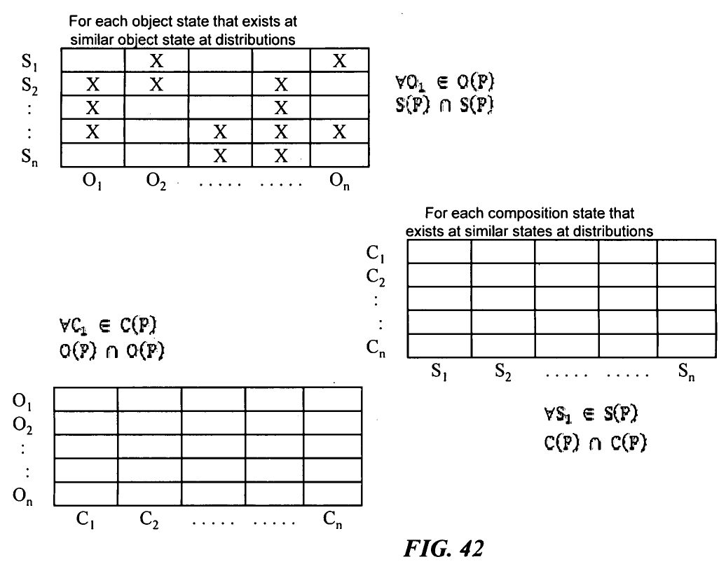

In order to define the state of a perspective, in a function known as “perception,” the following algorithms are used: For Perspective, P, given relationships E(P, tᵢ, tⱼ)=[Pₐ . . . P_{z}], C (P, tᵢ, tⱼ)=[P₁ . . . Pₙ], and O((P, tᵢ, tⱼ)=[Pₒ . . . P_{w}], a state (S) must be determined for SεS(P, tᵢ, tⱼ) for t₁=tₘ and tⱼ=tₙ. It is known: S(P, tₘ₋₁, tₙ₋₁)×S(E (P, tₘ₋₁, tₙ₋₁))→S(P, tₘ, tₙ), S(P, tₘ, tₙ)≡S(C (P, tₘ, tₙ)), and S(P, tₘ, tₙ) S(O(P, tₘ+t₀, tₙ+t₀) where all states sets are probability distributions. The function repeats itself until no change is observed in the perception cycle. An illustrative example of these functions is shown in FIG. 42. The output of the “perception” function is thus the reduced probability distribution of S(O(P, tₘ, tₙ)), which subsequently used to define S(P, tₘ, tₙ). The function of “perception” can be evaluated in several ways. The way herein describe is known as the “extrinsic instance state set,” however, there also exists a method to calculate a “weighted extrinsic state set” and an “intrinsic state set.” These methods are similar to the one described above and may be apparent to those skilled in the art.

Time is always a factor in the PML. Each set of perspectives is a finite state machine, which operates on the relative time of the perspectives. This means the frequency of a perspective is based arbitrarily on the time-lifespan associated with each perspective. The time frame with the most consistency and longest lifespan is then chosen by the algorithm as the relative time for the perspective. Each perspective is then indexed by time, with one state per time period.

Each state of a perspective is represented by the organization of a set of composite perspectives referred to as the “context” (sometimes referred to as “sub-context” as well). The perception function inherently relates the change in state of the perspective with the states of the set of perspectives organized in the related contexts.

The term “language,” as herein used, refers to a set or system of such symbols as used in a more or less uniform fashion by a number of people, who are thus enabled to communicate intelligibly with one another.

The term “paradigm,” refers to a set of assumptions, concepts, values, and practices constituting a way to view reality for the community that shares them, especially in an intellectual discipline. A “noun” may be defined as a word serving as the subject or object of a verb. A “verb” means a word that represents an action or a state of being. An “attribute” refers to a quality or characteristic inherent in or ascribed to someone or something.

The term “semantic memory” regards an individual's memory for meanings and general (or impersonal) facts. “perception” means the change in the state of a perspective due to the reception of a set of information across a context. A perception inherently relates the change in state of the perspective with the states of the set of perspectives organized in the related context.

The term “word” refers to a form of information perceived by a perspective over a perception duration (the time of the state transition) and is a unit of information. The word itself is composed of some arrangement of perspectives. “Information” refers to a state of an environment perceived by a perspective. The set of all information perceived by a given class of context is called the class of information. “Information” includes in its meaning an organization of perspectives that are perceived over a single time duration. Each word/message is defined onto a transmission medium by a set of contexts or sub-contexts. The set of words perceived is directly related to the organization of the sub-contexts of the perceiving perspective.

As used herein, the term “language” applies to a finite set of words, each of the same information class, that the context may perceive. That is, the finite set of words is herein called the “language” of the perspective. “Context” refers to an organization of perspectives which may perceive information. Each context may receive only one form of information and has one perspective. Context and information show how a perspective may be formed.

As used herein, type-0 perspectives form the most common form of perspective and each type-0 perspective perceives the environment through a context. A type-2 perspective perceives a perspective through a context by defining an object, perceiving its context, defining its environment, and defining the object's interaction with the environment.

All sets of perceptions are taken against the context of the object, which is equivalent to “language” of typical perspective. “Objects” form a consistent organization of a set of perspectives which is perceived by a perception. Each state of the organization of the object may be defined as a state of the context of the perspective, as perceived through a word of information. An object is defined onto a memory system by a set of contexts or sub-contexts.

The term “resources” pertains to a set or subset of all objects referable by context in order to make a perception.

Included in the present disclosure is a system and method for translating data from another program (such as Microsoft Excel) into the Perception-Modeling language. To do this, modeling classes are defined which includes the general relationship between objects without the instance of time. Algorithms will then sort the data into these modeling classes and store them in the object space. The algorithm then infers the number of possible states, which is adjusted according to the evaluated completeness of the information. The method for evaluating completeness will be described later. The algorithm then associates the different perspectives with any related perspectives, giving a PML model.

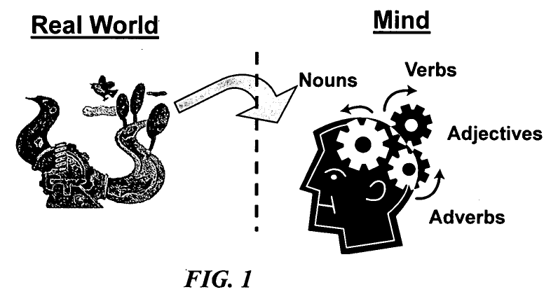

FIG. 1 is a conceptual depiction of how a human language paradigm seeks to model the real world. Problem—The potential to innovate in both software and the web is often viewed as a limitation of our tools. Perception Labs, however, views the potential to innovate as being limited by not only by tools, but more importantly by our use of language. Problem Overview—Our ability to Comprehend, Control, Communicate and Simulate the world around us breaks down when things get complicated. Comprehension, Control, Communication and Simulation are all enabled and limited by our languages. We must communicate with both humans and machines in today's world. Advances in technology have enabled a whole new level of utility—yet our application of language in process improvement remains relatively unchanged. Problem: Current language inhibits designers' ability to model and simulate processes in a meaningful, extensible and standardized manner. Problem—Symptoms So, what exactly is the problem with our language? Can we use language to ‘teach’ both man and machine without semantic disconnect? No. Can we use the same language in both? within an organization and within a computer system? No. Can we formulaically build off of existing bodies of knowledge? No. Can we simulate every system for efficiency? No.

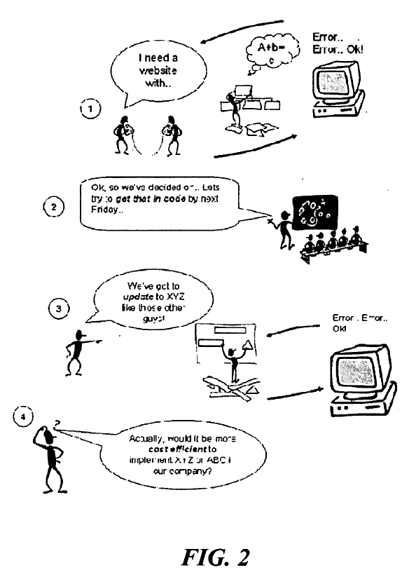

FIG. 2 illustrates problems relating to known language paradigms. The issues facing the Actor Model*—Computer scientists explain the Actor Model in terms of scalability, transparency, and consistency. (They are not concerned about inherent simulation—yet!) #1—Scalability—Using the model on local machines as well as remote machines. No Current solution. #2—Transparency—Bridging the chasm between local machine and remote machines. Requires mapping of Internet protocols and languages (XML, SOAP) to machine language (Java, C#). #3—Consistency—large knowledge systems use different terms for objects. Makes communication difficult without—>Mapping of terms.

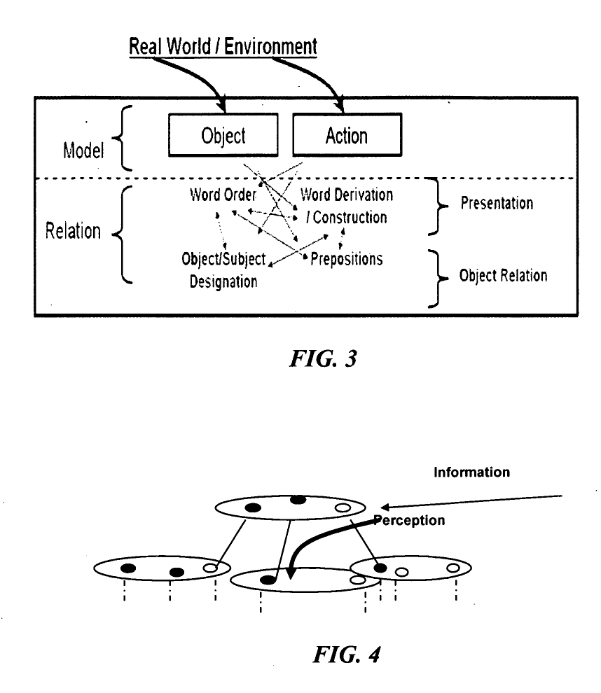

FIG. 3 provides a conceptual illustration of how languages include models of real world environments;

FIG. 4 discloses aspects of the perspective of the present disclosure;

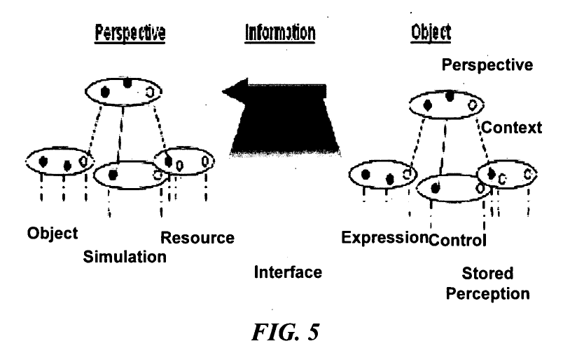

FIG. 5 presents aspects of the perspective-oriented modeling language of the present disclosure;

Goals of PML are to leverage the perception language paradigm by providing a clear set of goals which empower modelers of software applications. In simulation, PML provides a framework for accurately and efficiently modeling real-world systems and processes. Using PML allows for creating models more readily capable of predicting behavioral functions of a system over time.

In practice, PML allows a system modeler to simulate complex systems more accurately and at a lower cost. Using a mathematical model enables a modeler to derive a set of higher-level functions for describing systems as people perceive them. The PML framework allows every object to be broken down into these commonly defined pieces, thereby further allowing for efficient simulation that is limited only by the availability of the requisite information.

Communication is significantly improved with the presently disclosed PML framework. Consider the involvement of multiple people. Indeed, communication with an organization that is working to define, model and simulate a system is critical to the success of almost any major initiative. As an ideal, team members (or any modelers) should be able to perfectly communicate the exact semantic meaning of a defined system, at a cost of almost nothing.

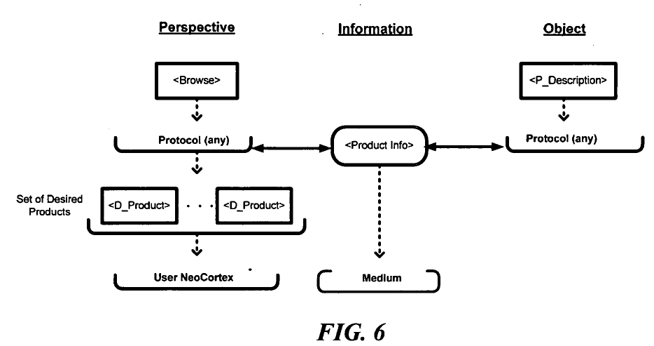

FIG. 6 illustrates concepts relating to how the present disclosure models various objects.

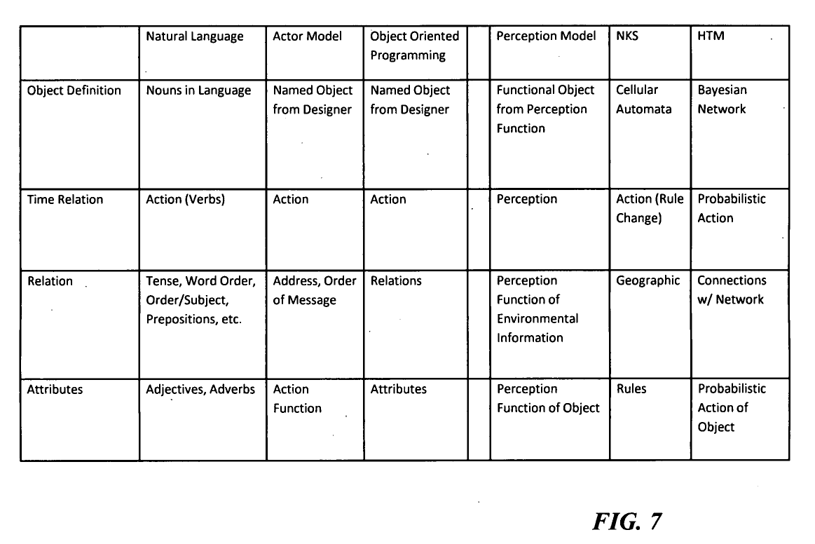

FIG. 7 depicts interaction aspects of the modeling environment of the present disclosure.

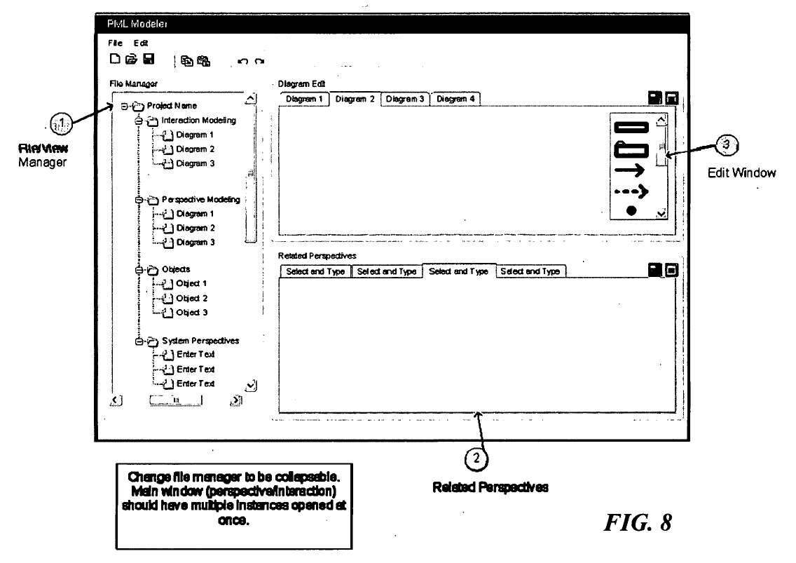

FIG. 8 shows how the subject matter of the present disclosure allows for efficiently simulation of various environments.

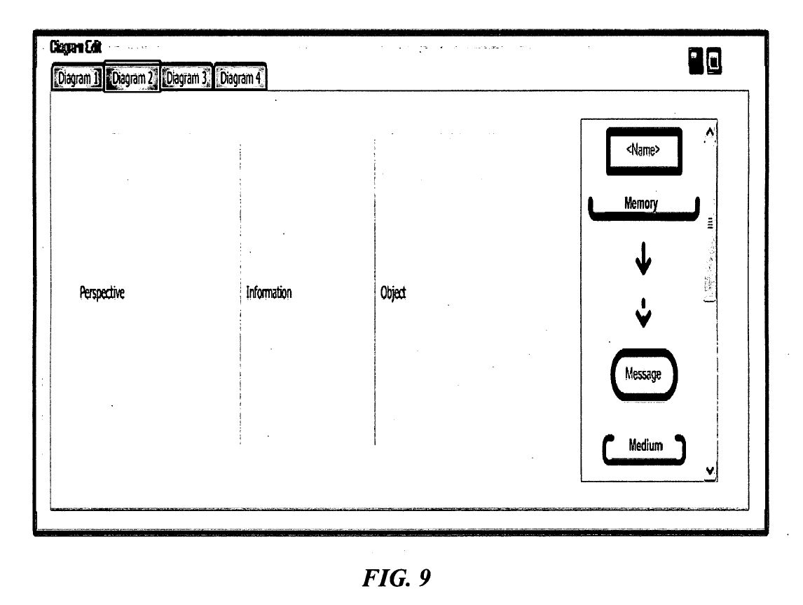

FIG. 9 illustrates the framework of the present disclosure in relation to various known language models.

PML should allow system modelers to communicate the meaning of defined, complex systems, more precisely and at a lower cost than any other modeling language. To achieve this criteria, a protocol within PML allows modelers to define objects in a “semantically precise” manner, when given access to a requisite amount of information about the object and the perspective which defines that object. The “semantic completeness” of a defined object is evaluated using the perception function so that other modelers may know the exactness of the definition. The “completeness” function is a user defined function for information entropy which evaluates the certainty of an observation of a communications relationship. By presenting objects and models in this fashion through PML, modelers may communicate about a system with precision, and they may also know where to focus their time and energy understanding or explaining a portion of the system that is not precisely defined semantically.

Another reality of modeling is that the modeler cannot have perfect information about a system, especially at the onset of a modeling project. Modelers must focus on understanding a system in pieces because the mind cannot simultaneously understand and express all the components of a complex, dynamic process. As a result, an inherent function of modeling a system is to observe empirical data about that system, put it into context, and then integrate it into the model itself.

Assuming that a modeler has limited capacity to understand the entirety of a system at any given time, a modeler may understand the system with a minimal cost and integrate this understanding into a system model at a minimal cost. PML also allows a system modeler to understand the functional behavior of a system, and integrate this understanding into a model at a lower cost than any other modeling language. To achieve the criteria of understanding, PML has application within a design environment for storing, sharing and using behavioral models. This understanding also enables more efficient communication processes, which allow for a more complete understanding outside of the design environment. In this way, a modeler may inherit models for adequately describing the behavior of a system that they seek to model. For example, a new online vendor may use a product distribution model developed by another online vendor to form an initial model that can be expanded or adjusted according to the needs of the new vendor. By making these different modeling structures available to new PML users, less time is required for the initial modeling of the user's information. Given the inherent scalability of the PML, each model can be easily expanded or reduced to fully encompass the information as required by each user.

With regard to the integration of knowledge and the extension of existing models, PML leverages a simplified design process. In conjunction with an object “completeness framework” (also mentioned above). The design process, while not linear, is designed to be much more iterative and consistent than current modeling languages. This measure of iteration and consistency of process across models allows the modeler to more easily pickup where he/she left off. Furthermore, the object “completeness framework” allows a modeler to see where new or more complete information about an object may be added.

The present disclosure provides a mathematical model based on a simple class of automata called perspective. The model enables the realization of a perspective-oriented language paradigm using perspective and extends the paradigm into a useful modeling language (PML). The present disclosure, therefore, includes a set of derived functions for modeling of real world, observable systems. A user may derive a set of modeling perspectives for PML for use in a complete modeling process. The process may include interaction modeling, behavioral modeling and structural modeling.

PML provides a simple mathematical model for deriving a class of automata which may be used to realize a perception-oriented paradigm. The primary function is perception, in the purest sense that it is the only function that there is.

The goal of a perspective is to create a complete mathematical behavioral model that relates the state of a perspective to various other states. This includes (1) the perspective environment, through information, (2) a past or future state, through a time relation called perception, and (3) the perspective structure, through a reflexive architecture. The perspective provides a model of behavior composed of a finite number of states, and a set of related transitions. Each state of a perspective is represented by the organization of a set of composite perspectives—this is referred to as the “context.” Each transition is enabled by a “word,” received by a “context.” in a function called a “perception.” Each context has one perspective.

Rules are restricted to be relevant only to “real world” paradigm. Every perspective has its own unique context. Every context may perceive only one class of information within its defined language. Objects are defined by a perspective. Perspectives and objects exist upon an “object space,” which is itself defined as a set of perception objects. An object space may exist as any sort of memory storage that is able to store perspectives and is limited to the space occupied by the stored perspectives. The most basic sub-contexts of an object space must be modeled functionally. Information exists upon a “transmission medium,” which is itself defined as a set of perception objects. The most basic sub-contexts of a transmission medium must be modeled functionally.

Another unique aspect of the present disclosure is the garbage collection function, which eliminates stored perspectives in the object space as the number of related perspectives existing in the perspective set falls below a user-defined number. This means that perspectives will only be eliminated if the number of related perspectives has become too low for the perspective to be considered relevant to the overall context. In addition to clearing more object space for future perspectives, this function allows for more efficient simulation by eliminating a number of perspectives which may be only weakly linked to the overall context and thus reduce the accuracy of the model. The less related perspectives a perspective has, the more likely it is to be eliminated during the garbage collection process. This leaves the most relevant perspectives, meaning the ones with a number of related perspectives, in the object space. For example, a perspective which occurred only once for an object will be removed since it has only one channel to any other perspective. This description above refers only to one possible embodiment of the garbage collection function and is not meant to be limiting.

Contexts/objects exist on a memory structure, wherein semantic memory involves outside information to build and extend upon existing ideas. When a context may interact with the environment (usually to send information) through a set of sub-contexts, this is known as a First Order Derived Function.

The present disclosure includes a perspective information/object framework wherein a perspective may be stored onto a memory system in a state that remains constant until the location of the stored perspective is changed by command. A context may control the movement through a set of perspectives in coordination with a negative feedback system, the perceived state of a defined object, and the goal state of a defined object.

Control may be realized as a function of expression, feedback (ongoing perception) and time. Control involves an object to interact (through a feedback loop) with an Interface, that creates and reads a Stored perception. Communication involves the exchange of information between two objects, such that each object has a semantic understanding of the information through a common protocol.

Communication may be realized as a function of expression, perception, feedback and time. Communication involves an object to interact (with open feedback) with another object, through a common protocol and a representation upon a common transmission medium. Each object must perceive and express based on a stored perception, which realizes said protocol.

In the modeling process, PML aims to define a goal for a defined perspective, and then model various scenarios as to how this goal would be accomplished by interacting with the environment of that perspective. The end result is that the modeler of the system should be able to evaluate various scenarios for getting to the goal state, especially with regards to the expenditure of resources. Because PML breaks objects down to a set of communication components, modeling the defined system for communication efficiency ensures that the goal state is achieved in the most efficient fashion.

With the disclosed subject matter, all systems should be modeled for communication efficiency through a simulation of interaction with the environment. In order to build the most useful models for evaluating the communication efficiency of a system, the ideal model for behavioral simulation of the system must be considered. Effectively, this means that with the minimal amount of information about a system, the present disclosure may accurately simulate the behavior of the system over a given time period. In this sense, the present disclosure considers the cost of modeler understanding to be the limiting factor of modeling, and assume that the cost of the simulation itself is relatively minimal. Making this assumption, the most efficient way to model is to consider the most general behavioral model of a system that may be applied across the entirety of a system.

In the way that objects are defined in PML, this means that, in order to realize the most efficient model for a system, the present disclosure effectively need to define a single functional model for each object space defined within the system. In this sense each object considered upon a defined object space may be realized through this base functional model and some set of contexts. In this way the modeler may consider the minimal amount of behavioral models, while still preserving the ability to simulate the behavior of the entire system.

All objects should be realized with the most generalized and basic set of functional models to enable efficient simulation. Given the fact that the present disclosure may not have perfect information about the systems that the present disclosure model, it may not be possible to generalize the function of objects, even if they exist upon a common memory system. Furthermore, due to the fact that all human modelers may be starting from the point of a semantic or “named” object definition, the present disclosure must make considerations for this level of observation and understanding. Lastly, the present disclosure consider that development relies not just on one person, but most often an organization of people who must be able to work together to evolve the utility of a system model.

Given these three constraints of reality—imperfect and incomplete information, human understanding and inter-human communication—the present disclosure leverage a simple set of constructs which aid in the development process. Having imperfect and incomplete information about a system or an object may limit its ability to be simulated for communication efficiency. As a modeler, then, the challenge in dealing with this scenario is the following: To leave system models in a state that they may be extended at a later time (after gathering of pertinent information for instance); to know where to add in more information about an object or system as quickly as possible; and to know what information to integrate (or upgrade) into a system as soon as it becomes available.

To facilitate this reality in the most efficient way possible, PML uses a hierarchy to define the perspective, Information, object relationship of any defined object.

| Perspective | Information | Object |
|---|---|---|
| Named | Named | Named |
| Functional | Language | Functional |
| Partial | Partial | Partial |
| Complete | Complete | Complete |
| Composition | Medium | Composition |
| Partial | Partial | Partial |
| Complete | Complete | Complete |

Given that human modelers perceive the world in terms of their semantic memory, it is preferable to start any modeling process with simple “named” objects. Regardless of the modeler's understanding of the object function or structure, the starting point for any object definition is simply to give that object a name which has semantic meaning to the modeler. The challenge, then, becomes to extend a named model to be defined in terms of a functional model, and possibly a set of sub-contexts onto a functional model.

Development of complex models involves a team of contributors. Given this scenario, PML lends itself well to concise communication between members of an organization through the use of the perspective/Information/object paradigm, in conjunction with the “Completeness” hierarchy. The joint use of these two pieces of PML allows for the seamless communication, sharing and co-development of object models between individual development efforts.

Modeling in PML is about efficiently defining as many objects as possible in terms of perspectives, in order to realize simulation of that object's behavior in a system.

In examining the above considerations, the present disclosure considers a method for determining sequence when in modeling the transition to a goal state of a defined perspective. In the general sense, the present disclosure calls this type of modeling interaction modeling. Interaction modeling can, in theory, be applied to any state change of a defined perspective. We know that each state transition involves a certain set, or words, from the environment in order to invoke the state change.

In examining further principles of the present disclosure, a method is also provided for relating functional models for object spaces with higher level contexts on that memory system. Here, the present disclosure considers a type of modeling called perspective modeling. Perspective modeling provides a set of modeling perspectives that allow for the breakdown of objects into their functional components, and, given enough information, into ideal perspectives.

Interaction modeling and perspective modeling work together to create the most useful and efficient simulation for the system in question. In order to realize the goal state of a defined, named perspective, the present disclosure first defines the state change, and then the name of the perceived information useful in invoking this state change. These interactions may come from some sequence of functions across a set of contexts within the environment of the perspective.

Each function involves a defined context class, including a description of its functional state change. To clarify these sequential sets of functions, each function is broken down into its most functional components, in the sense that the derived functions must be broken down as is explicitly defined in the PML language. Sequences are updated accordingly.

Interaction modeling may enable the modeler to observe the resource expenditure involved in the given transition, so that the sequence may be modeled efficiently. Named perspective modeling includes sequence (ideal) diagram modeling perspective, context class modeling perspective, and resource context Class modeling perspectives. Also, an alternative Path modeling perspective and system Simulation modeling perspective is enabled by the present disclosure.

For each interaction, details of the interaction over time between system elements relate perceptions with objects, contexts. Sequence modeling determines the primary set of transitions in a given context, but not necessarily all transitions. A perspective diagram simply that identifies the name of the perspective and the name of the object it defines, at a minimum. The diagram also allows for the definition of a named “object space,” and named information.

Robustness modeling facilitates the function of breaking down a derived function into more basic functions so that interaction may be modeled. “Activity” modeling details alternative steps that could occur in a communication process other than the direct communication towards a goal. In the case that the perception onto the object does not achieve the goal, there must be a perception transition defined that details the next system interaction. Activity modeling may help to round out the set of all perceptions in a given context. Resource modeling examines the resources for each interaction. Advanced versions may simulate interactions using any relevant resources and select the most efficient set.

Perspective modeling is the process of gathering and applying information about a perspective/information/object “triple” to define the function and structure of the perspective, information exchanged between the perspective/object, and the object itself. With perspective modeling, objects get broken down to be modeled with regards to perspectives. Each interaction details the information (both word and information type) being transferred. It also details the “completeness” of each diagram relative to its structure. Information interactions may help define the related object structure and transmission medium.

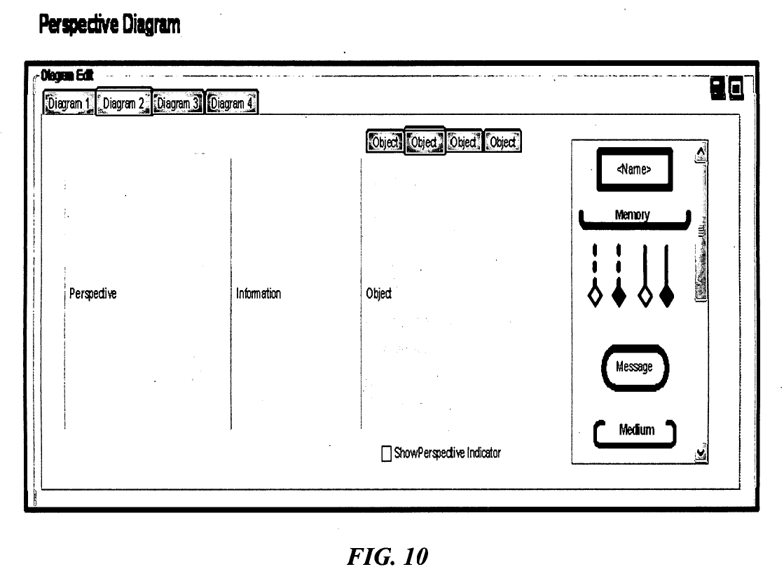

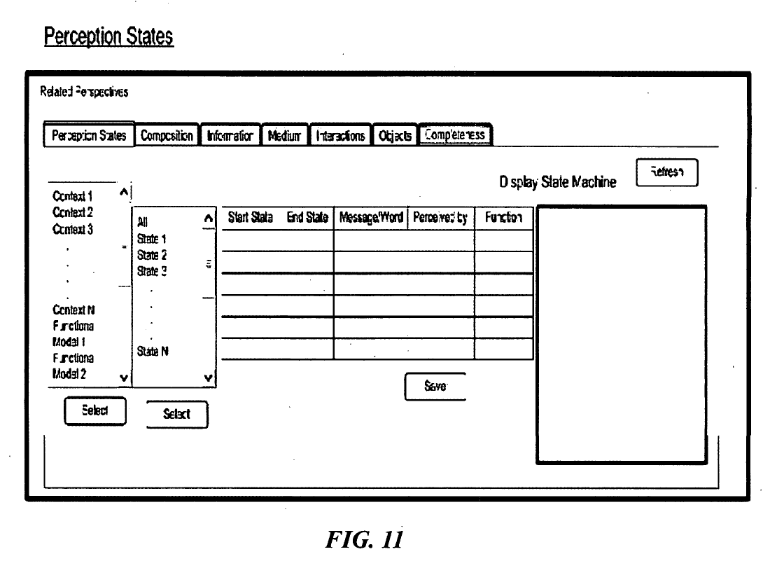

FIG. 10 provides one implementation of the disclosed subject matter for using the perspective-based modeling language of the present disclosure.

FIG. 11 shows a first example of a computer user interface for enabling the concepts of the disclosed subject matter.

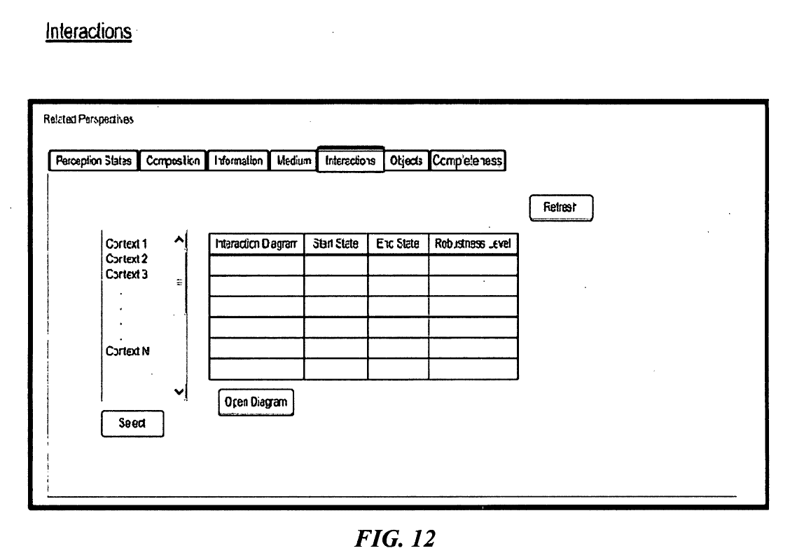

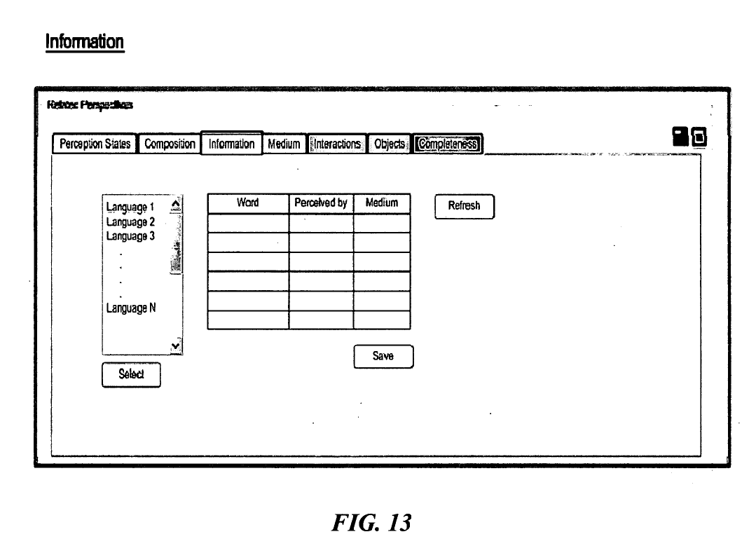

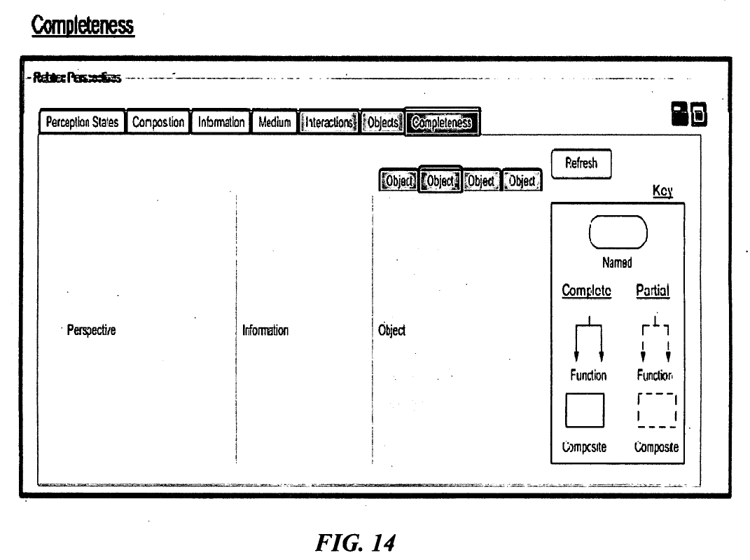

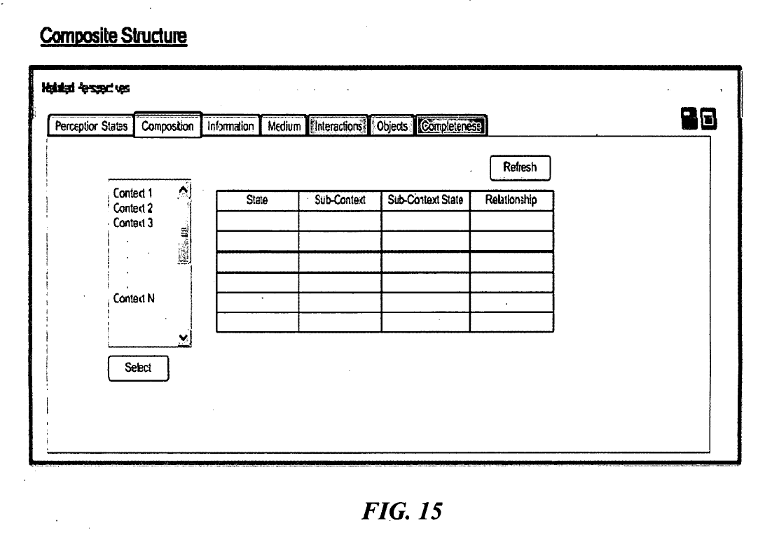

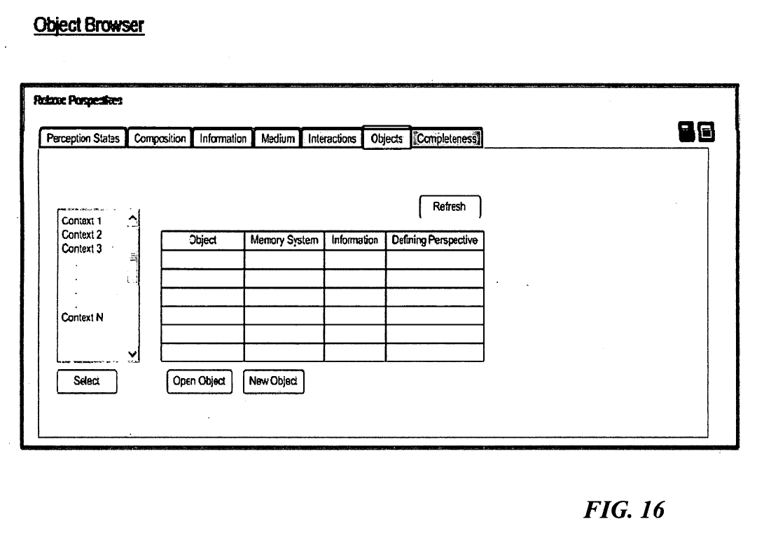

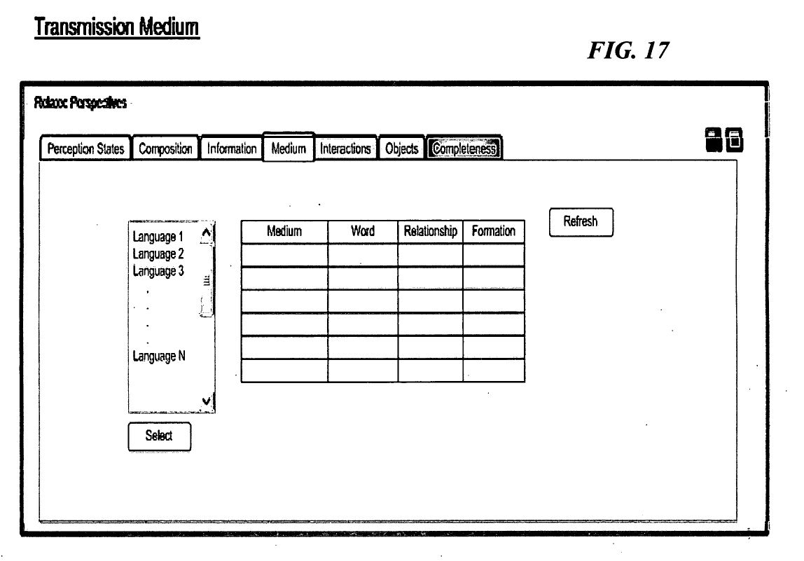

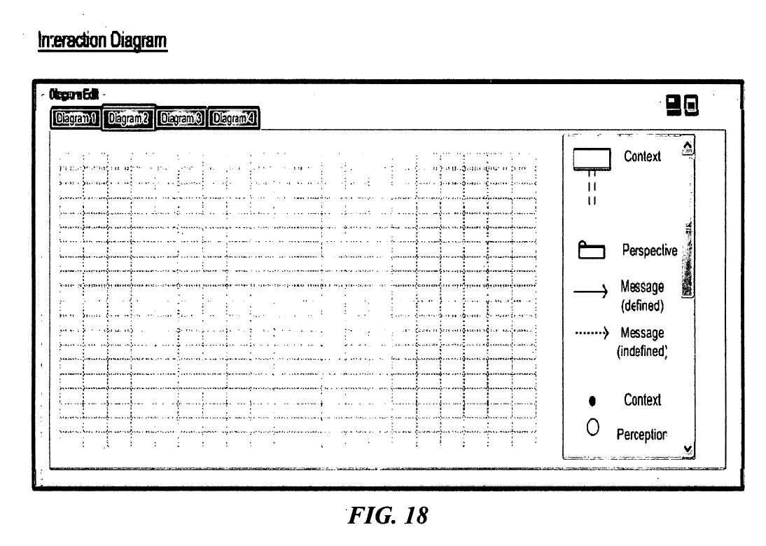

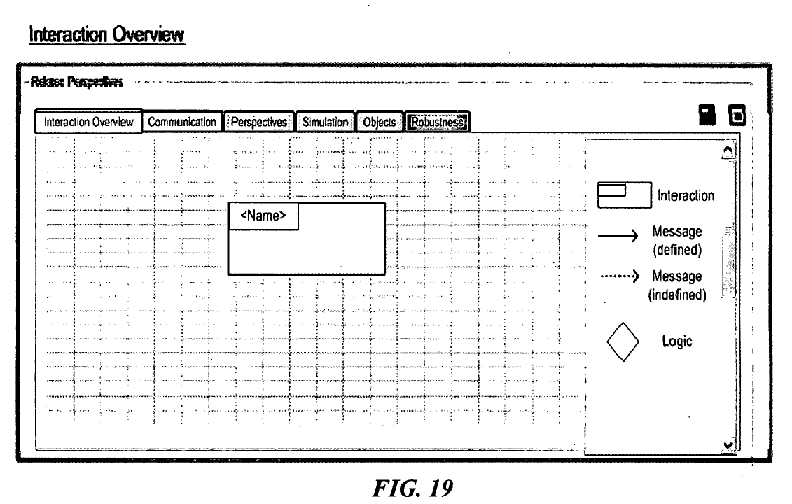

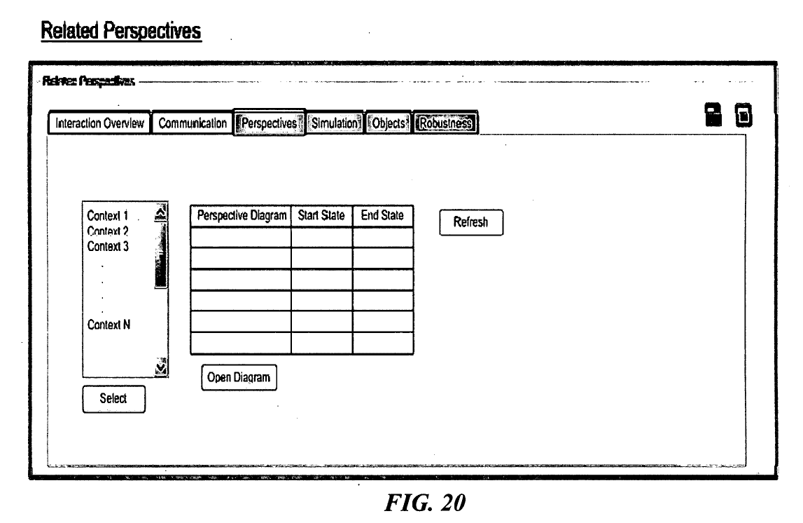

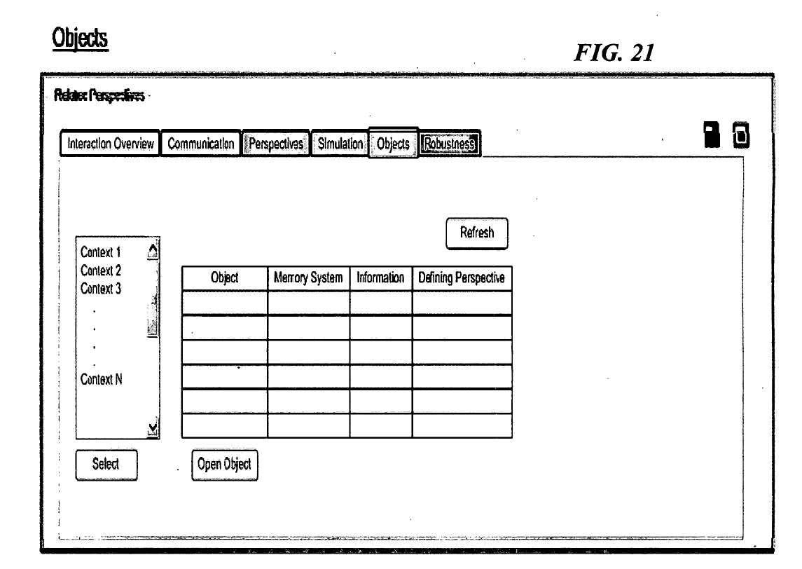

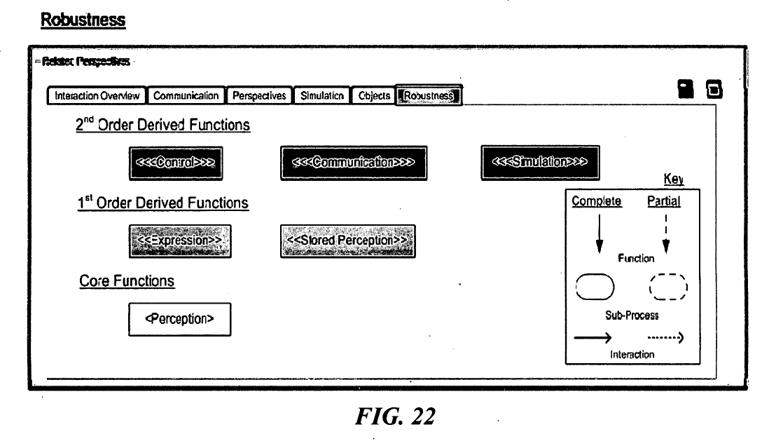

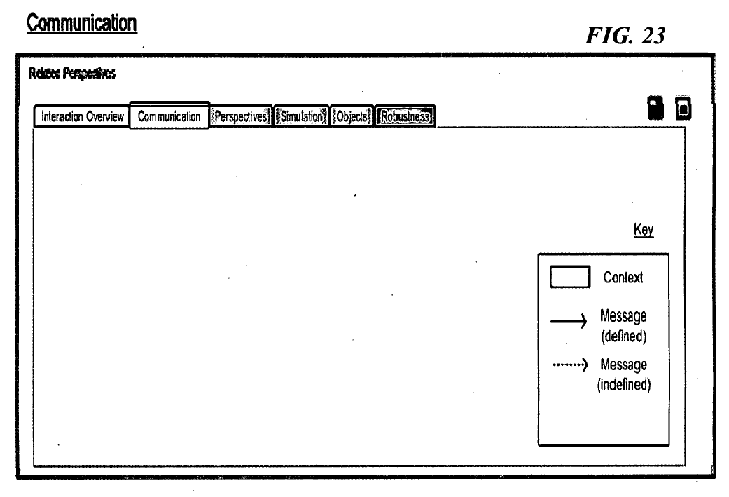

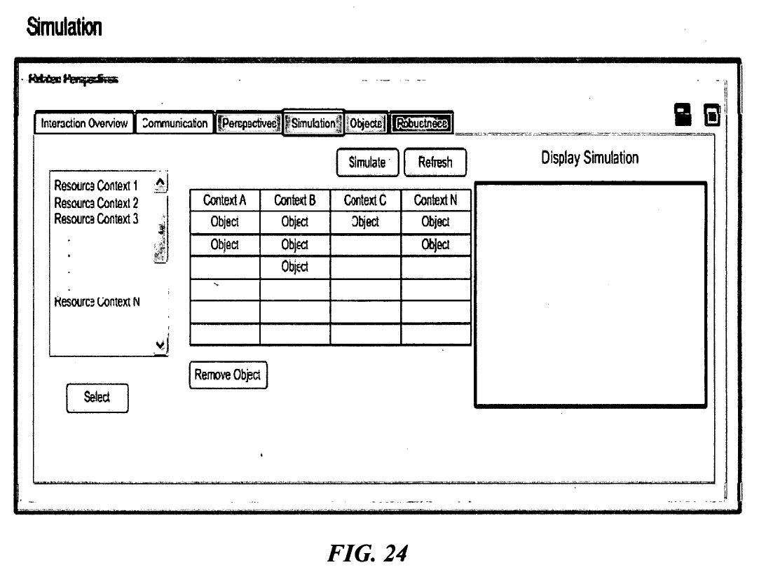

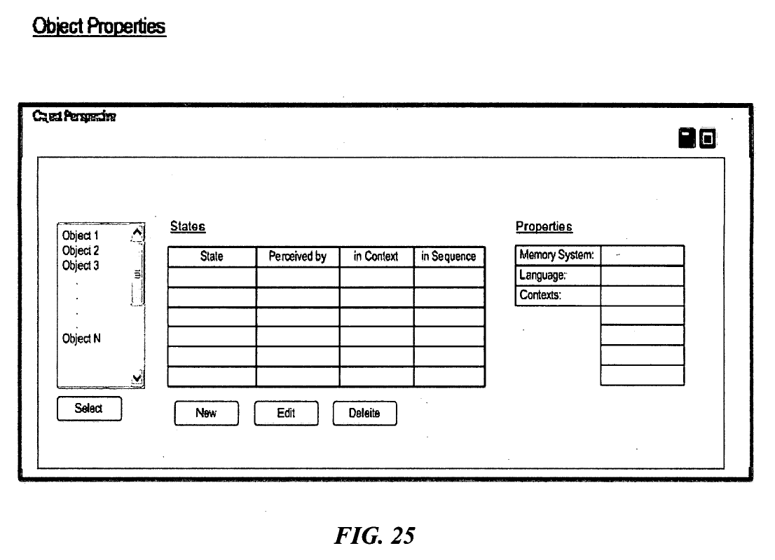

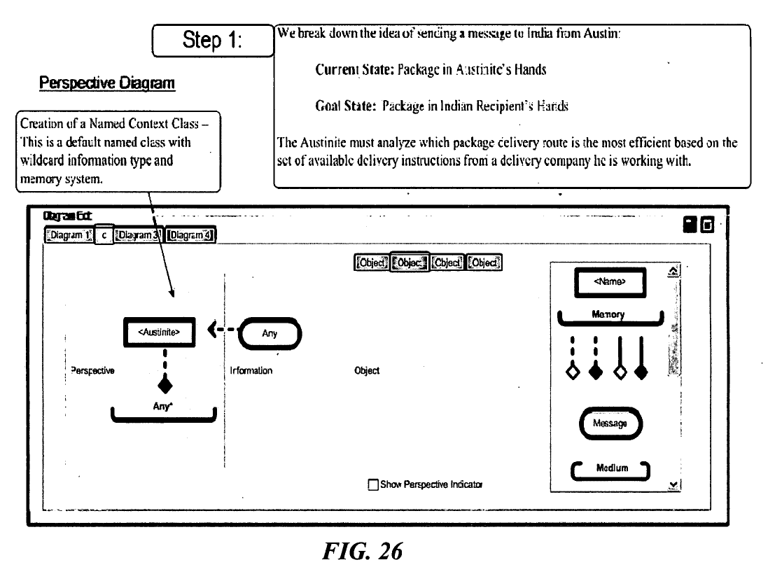

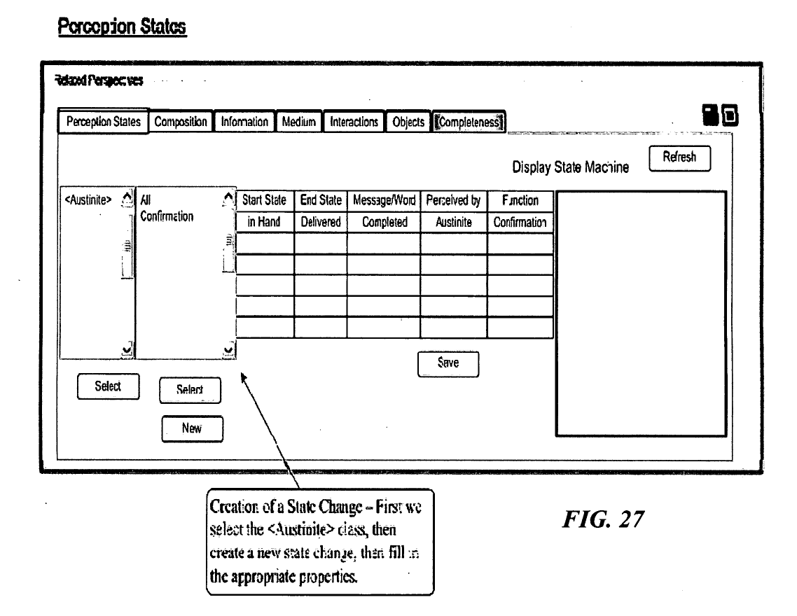

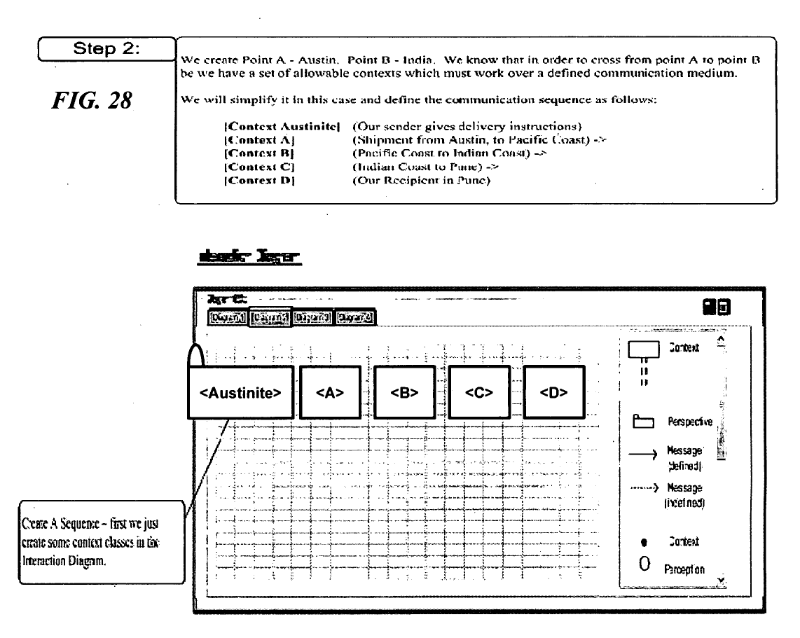

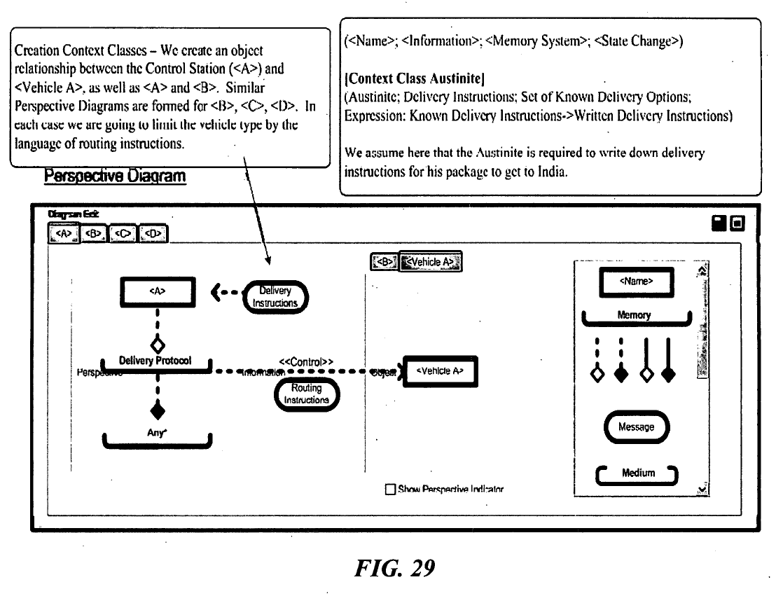

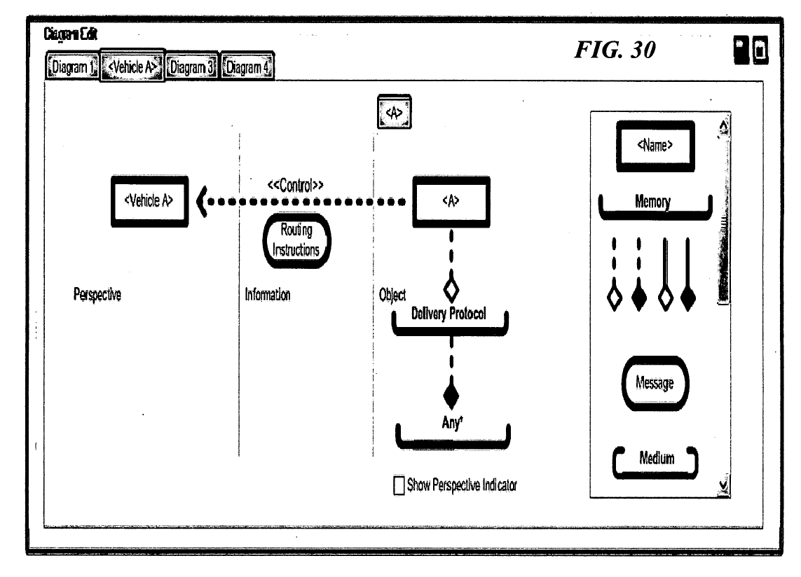

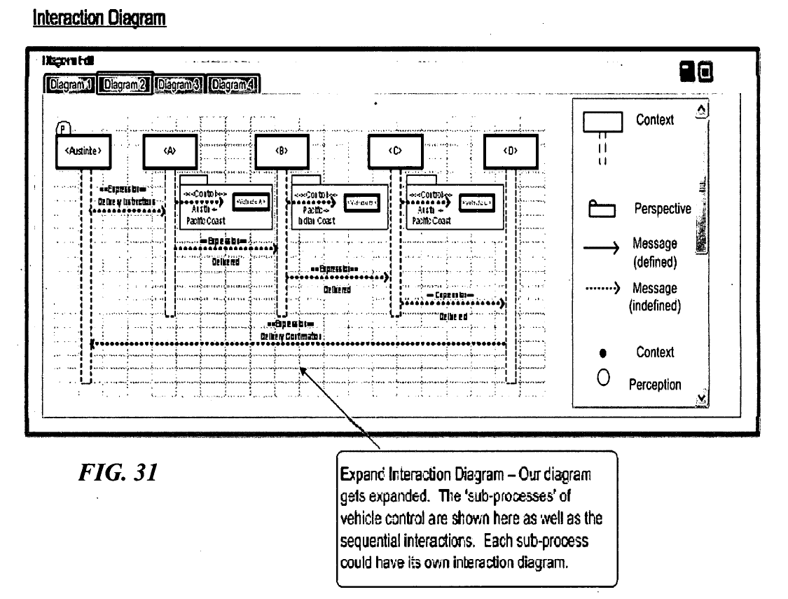

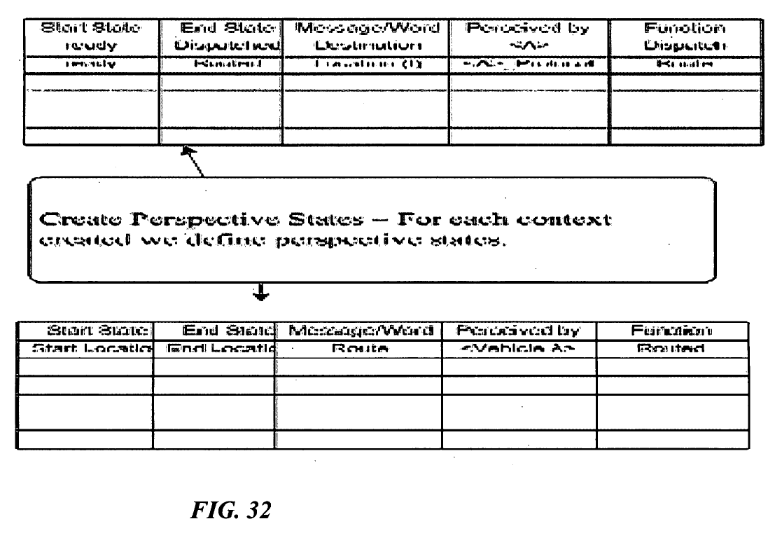

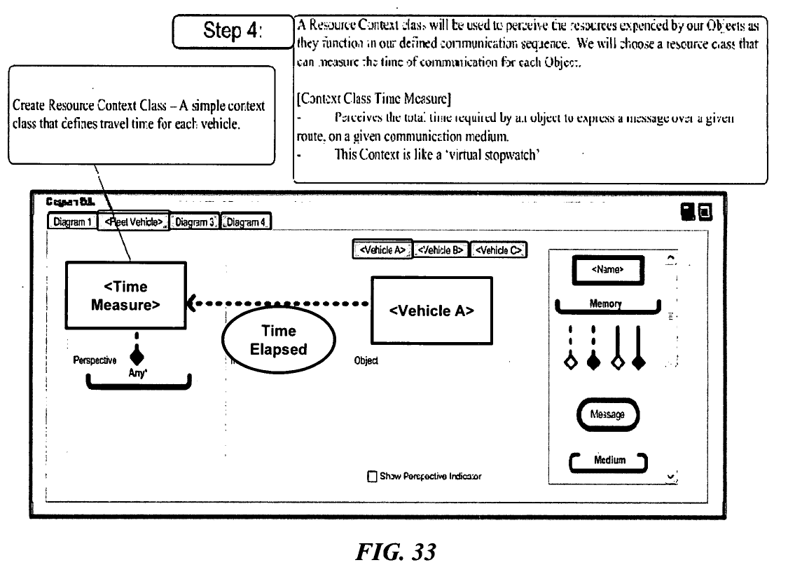

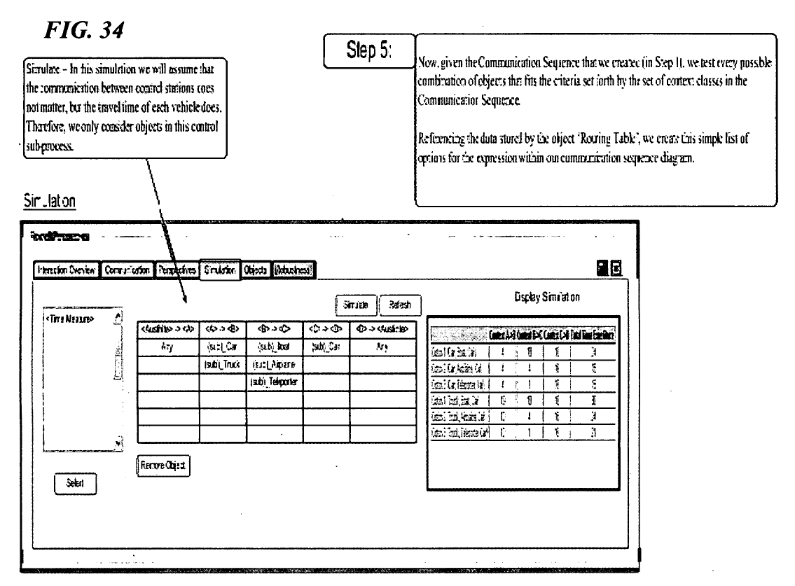

FIGS. 12 through 25 show templates and interfaces for a computer-based embodiment of the presently disclosed subject matter.

FIG. 2 26 through 34 provide an illustrative example of the presently disclosed subject matter.

As seen above, the processing features and functions described herein may be implemented in various manners. For example, the present embodiments may be implemented in an application specific integrated circuit (ASIC), a microcontroller, a digital signal processor, or other electronic circuits designed to perform the functions described herein. Moreover, the process and features here described may be stored in magnetic, optical, or other recording media for reading and execution by such various signal and instruction processing systems. Another embodiment may be the use of the PML over a webpage, wherein the modeling is done using a virtual machine that utilizes PHP and API to provide a web-based modeling program, in which the object space for perspectives are stored on a central server. The foregoing description of the preferred embodiments, therefore, is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A method for communicating according to the perspective of at least two communicators, comprising the steps of:
forming a model comprising a predetermined number of states and a plurality of related transitions;
representing each of said predetermined number of states according to a plurality of perspectives, said perspectives comprising a plurality of states and a set of related transitions;
forming a perspective language by deriving a plurality of functions associating said plurality of perspectives for representing at least one actually observable system, and
deriving a set of modeling perspectives for modeling said at least one actually observable system.

2. The method of claim 1, further comprising the step of forming said perspective language by deriving a plurality of functions associating said plurality of perspectives for representing a plurality of associated actually observable systems.

3. The method of claim 1, further comprising the step of deriving a set of associated modeling perspectives for modeling said plurality of associated actually observable systems.

4. The method of claim 1, further comprising the step of deriving a set of interaction modeling perspectives for modeling a plurality of interactions amongst said plurality of perspectives.

5. The method of claim 1, further comprising the step of deriving a set of behavior modeling perspectives for modeling a plurality of behaviors amongst said plurality of perspectives.

6. The method of claim 1, further comprising the step of deriving a set of structural modeling perspectives for modeling a plurality of structures relating to said plurality of perspectives.

7. The method of claim 1, further comprising the step of representing each of said predetermined states according to a context, said context comprising an organization of a set of perspectives.

8. The method of claim 7, further comprising the step of performing a perception for said set of modeling perspectives for enabling said set of related transitions by receiving a word across said context.

9. The method of claim 1, further comprising the step of performing a perception function for said perspectives by changing the state of associated perspectives in response to receiving a set of information across a context.
